(19) United States
(12) Patent Application Publication
(10) Pub. No.: US 2005/0220997 A1
(43) Pub. Date: Oct. 6, 2005

(54) Method and device for producing hollow bodies

(76) Inventors: Volker Kronseder, Neutraubling (DE); Heinz Humele, Thalmassing (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/517,556

(22) PCT Filed: May 27, 2003
(86) PCT No.: PCT/EP03/05548

§ 371 Date: May 23, 2005

(30) Foreign Application Priority Data
Jun. 12, 2002 (DE) 102 26 017.6

(51) Int. Cl. B05D 7/22; B05D 3/02; B05D 1/04

(52) U.S. Cl. 427/230; 427/372.2; 427/458; 118/621

(57) ABSTRACT

A method and device for producing hollow bodies comprising a gas barrier coating, in particular PET containers comprising a coating of polyvinyl alcohol. The hollow bodies are treated in a device for increasing the surface energy of the surface to be coated and then in a coating device and a drier. To improve the gas barrier effect of the gas barrier coating, a multi-stage pre-treatment is disclosed, in which the hollow body is subjected to an electrostatic discharge after the treatment for increasing the surface energy.

### DESCRIPTION

The invention relates to a method and a device for the manufacture of hollow bodies of the type described in the preambles of claims 1 and 8.

Large numbers of methods and devices for the manufacture of hollow bodies, in particular single-use and multiple-use containers made of a polyethylene terephthalate (PET), are known. In particular, drink bottles made of PET are becoming increasingly predominant in the market, because they are very light, suitable for food, and they can be manufactured in a cost advantageous manner and present sufficient mechanical resistance. However, one drawback of PET is the fact that it is permeable to gases, such as, for example, oxygen or carbon dioxide. If oxygen penetrates from the outside to the inside, or if carbon dioxide escapes from carbon dioxide containing drinks from the inside to the outside through the PET wall, this can lead, in both cases, to a large decrease in the service life. For that reason, attempts are made to lower the gas permeability using appropriate coatings. One method for the manufacture of hollow bodies of the generic type is described, for example, in DE-OS 29 05 480. In the known method, a preform made of the container material is first coated with polyvinyl alcohol. Although polyvinyl alcohol produces a very good gas barrier and is compatible with food, it is water soluble, and therefore the polyvinyl alcohol coating, after it has dried, is provided with an additional coating which is less sensitive to humidity. After this layer has also been dried, the preform is then shaped to the finished container, usually by blow molding, during which process the coatings are also shaped and thus they cover the entire finished container. One problem here consists of the adhesion of the polyvinyl coating to the hollow body. In known methods, a surface treatment is used immediately before the first coating process to increase the surface energy, whereby the surface energy is increased from approximately 38 mN/m for the untreated surface to a maximum of 52 mN/m. This process can be, for example, a corona treatment or a flaming, or it can consist of the addition of a surfactant or similar agent to the polyvinyl alcohol. Nevertheless, it should be noted that the barrier properties of the coating cannot be improved as much as one would expect.

This problem is addressed in DE 27 17 307 D2. In that patent, it is noted that bubbles form in a coating, which are thought to be caused by carbon dioxide diffusing through the PET wall. In the method described in this patent, an attempt is made to prevent this effect by applying the coating to the internal side of the hollow body. However, the coating of the internal side of a hollow body is more complicated than the coating of the external side, and it is only suitable for a limited number of coating agents and not for all application purposes.

The invention is thus based on the problem of providing a method and a device for the manufacture of hollow bodies with an improved gas barrier coating.

This problem is solved by the method according to claim 1 and the device according to claim 8.

The present invention is based on the knowledge that, using the claimed, careful, multi-step preliminary treatment, it is possible to effectively suppress bubble formation and the associated decrease in the barrier effect. As a result of the electrostatic discharging of the surface after the treatment to increase the surface energy, the adhesion of the coating can be evened out, so that bubble formation no longer occurs.

It is advantageous to carry out this discharge using an air shower with ionized air, where, as a result of the mechanical blowing, any adhesive microparticles attracted by the electrostatic charge are also blown off.

If one expects, for example, fatty deposits originating from mold removal agents in the case of injection molded preforms, then it is advantageous and usually also necessary to remove the fat prior to a treatment to increase the surface energy.

An additional possibility to improve the barrier properties of the coating consists in conferring a substantially higher surface energy than has been done to date in the state of the art. According to the invention, the surface energy is increased to values above 60 mN/m, and preferably above 70 mN/m. To increase the surface energy to these values, it is appropriate above all to use the known flaming method.

An additional possibility to improve the barrier properties of the coating, according to the invention, consists of a gentle blowing process at lower temperatures (below 60° C., preferably at 45° C.), using, however, a highly dehumidified air, which preferably has a water content of less than 3 g/m³. As a result of this type of drying, an even and complete drying throughout the entire layer thickness is achieved, so that any remaining residual humidity content is distributed evenly throughout the entire coating and the formation of a skin is suppressed. On the other hand, dryers, when used under microwave or infrared radiation, produce a more rapid drying, but they are associated with the risk that a higher than desired residual humidity content remains under a very dry, crumpled, surface skin, where the crumpled surface persists even after the blowing process.

An additional possibility to improve the gas barrier properties consists in applying the gas barrier coating by blowing, where one must ensure that excess coating agent is applied to the surface to be coated in such a manner that the coating agent is not immediately rinsed off again. If the next step consists of a film formation section, then the excess can drip off slowly, so that a completely covering film has already formed before a stronger dryer effect is applied.

Embodiment examples of the invention are explained in greater detail below, with reference to the drawing. In the drawing:

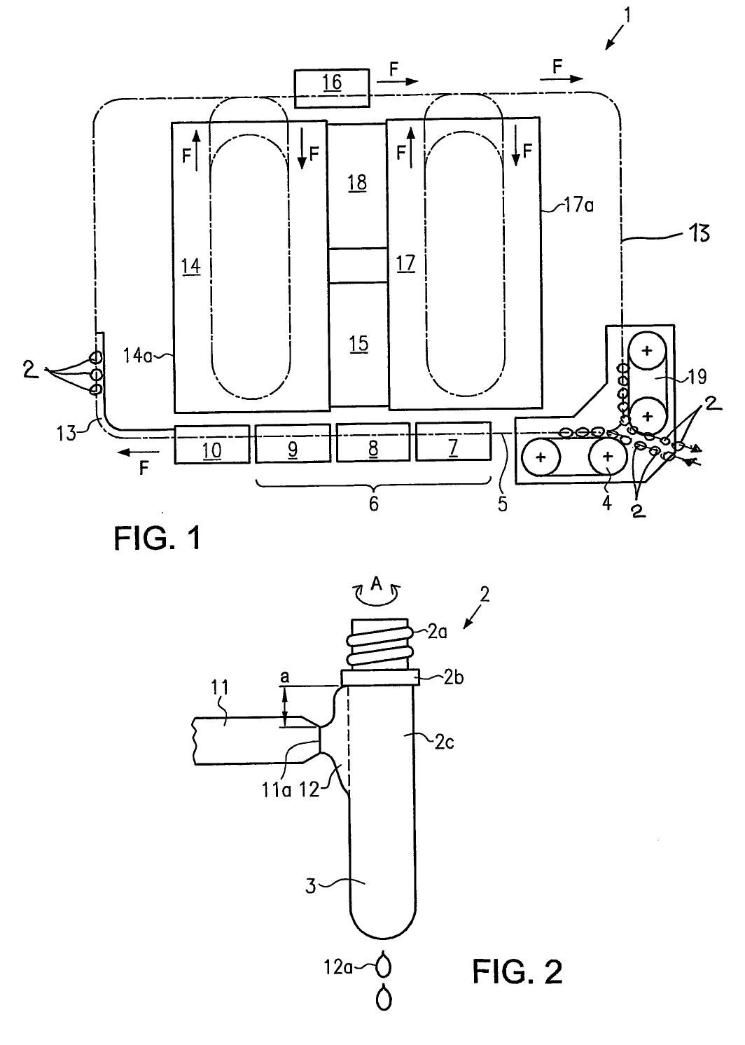

FIG. 1 shows a schematic top view of a device according to the invention for carrying out the method according to the invention, and FIG. 2 shows a schematic representation of a hollow body during the coating.

FIG. 1 shows a highly schematic top view of a part of a substantially automatic and continuous device 1 for the manufacture of hollow bodies 2 (FIG. 2) with a gas barrier coating 3. The hollow bodies 2 can be the conventional preforms (preforms), as used for manufacturing drink bottles or similar containers. However, the device 1 according to the invention can also be used to coat hollow bodies which have already been finished.

The hollow bodies 2, which are designed as preforms, consists, in the preferred embodiment example, of a polyethylene terephthalate (PET) which is conventionally used for manufacturing drink bottles. Such preforms present an already finished threaded head 2a, which is separated by a projecting flange or collar 2b from the body 2c proper, which is to be coated and has closed ends. The projecting flange 2b, on the one hand, serves as a holding element for known transport or gripping devices, by means of which the hollow bodies 2 can be transported individually suspended and optionally with rotation in the direction of the arrow A about their longitudinal axis through the device 1. On the other hand, the flange protects the already finished threading during the processing.

Using, for example, a conveyor 4, the hollow bodies 2 are transferred individually one after the other into the device 1, which can be optionally encapsulated, so that operations under clean-room conditions are possible. However, it is also possible to connect the device 1 directly to a manufacturing section for the hollow bodies 2.

From the conveyor 4, the hollow bodies 2 are transferred to a linear conveyor 5, which extends through the entire device 1 and which can be, for example, in the form of an endless conveyor chain fitted with spikes which can be inserted into the preforms. This conveyor 5 first conveys the hollow bodies 2 through a multi-step preliminary treatment section 6. The preliminary treatment section 6 contains, in the conveyance direction F, a device 7 for degreasing after the conveyor 4. The device 7 preferably contains washing nozzles, which should be directed onto the part 2c to be coated of the hollow body 2. It is preferred for the conveyor 5 to be designed in this area in such a manner that the hollow bodies 2 rotate. It is preferred to use ethyl alcohol (ethanol) for a greasing agent, and to spray it through nozzles onto the hollow body, so that the latter is completely wetted.

In the conveyance direction F which follows, the preliminary treatment section 6 contains a device 8 to increase the surface energy. It is preferred for the device 8 to be a flaming device, as already used for this purpose in the state of the art. However, the flaming device 8 is adjusted in such a manner that the surface energy can be increased to values above 60 mN/m and preferably above 70 mN/m. In the area of the device 8, the conveyor device 5 is also designed in such a manner that the hollow body 2 rotates about a vertical axis.

The preliminary treatment section 6 contains, in the conveyance direction F after the flaming device 8, a device 9 to lower the electrostatic charging or to discharge the surface to be coated of the hollow body 2. The device 9 in turn contains nozzles which are directed onto the area 2c to be coated of the body 2, through which jets of ionized air are blown against the hollow body 2. As a result of the ionized air, the surface is discharged, and at the same time any adhering particles are blown off by the air jets. In the area of the device 9, the conveyor device 5 is also designed in such a manner that it rotates the hollow bodies 2 about their vertical axis.

After completion of the preliminary treatment section 6, the coating proper occurs, preferably on the external side of the hollow body which is still warm from the flaming. In the process, the hollow body 2 passes through a first coating device 10, in which a gas barrier layer 3, preferably based on polyvinyl alcohol, is applied. The coating agents for such gas barrier layers are known to the person skilled in the art and they do not have to be explained further here. It is preferred to use a polyvinyl alcohol with a high hydrolysis degree of more than 99.9 mol %, which is dissolved in fully desalted water. The coating agent preferably contains no additional additives, in particular no wetting agent. The coating agent has a concentration of 5-12% and it is processed at room temperature.

The coating agent is preferably applied by blowing, as shown in FIG. 2, where a nozzle 11 leads an aqueous solution of polyvinyl alcohol 12 in a blow jet against the surface 2c to be coated, where the nozzle M and hollow body 2 move relative to each other; and it is preferred for the hollow body 2 to rotate. The quantity of the coating agent 12 exceeds the quantity which would be sufficient for to completely cover the surface 2c to be coated, so that the excess drips off in drops 12a. The upper edge of the nozzle opening 11a of the nozzle 11 is located at a separation distance a below the collar 2b, where the separation a is measured in such a manner that the coating agent 12 is blown to a location below the collar 2b without going over the collar 2b, so that, in this manner, the threading 2a is effectively protected against undesired coating. The separation a, in the case of the hollow bodies 2 which are usually used for the manufacture of PE bottles, is approximately 20-25 mm, but it depends on the special viscosity of the coating agent 12 and on the quantity used.

The viscosity and the quantity of the coating agent 12 is chosen in such a manner that, on the surface 2c to be coated, a single layer with sufficient layer thickness of the coating agent 12 continues adhering, where this single layer still guarantees a complete coverage with a thickness of approximately 2 μm, even after the blowing of the hollow bodies 2 to form the finished containers.

After the first coating device 10, a drip and film formation section 13 follows, in which the final layer thickness is established.

Then the conveyor 5 leads the hollow bodies 2 into a first dryer 14. The first dryer 14 presents a closed housing 14a, in whose interior, the conveyor 5, while including straight sections, coils upward, that is perpendicularly with respect to the drawing plane 1, until it leaves the housing 14a of the dryer 14 again in the upper area.

The drying of the coating agent 12 in the dryer 14 occurs in air and under mild conditions using low temperatures below 60° C., and preferably a temperature of 45° C. A device 15 is associated with the dryer 14, which device dehumidifies the air used for the drying, preferably to a value of less than 2-3 g water per cubic meter air. In this manner, an optimal complete drying of the coating agent 12 on the hollow body 2 in relatively short time is guaranteed, for example, in approximately 3 min.

The hollow body 2 with the completely dried gas barrier layer 3 leaves the dryer 14 in the upper area and reaches a second coating device 16, in which the polyvinyl alcohol gas barrier layer 3 is covered by an additional layer, which increases the mechanical resistance and the resistance against water. In the second coating device 16, the coating based on polyvinyl butyral or another alcohol soluble coating agent, for example, is applied. The coating can also occur by blowing, where one must ensure that the coatings overlap, so that the gas barrier layer 3 is also covered in the transition to the uncoated collar 2b. Polyvinyl butyral requires a nonaqueous solvent, where it is preferred to use ethyl alcohol (ethanol).

After leaving the second coating device 16, which can be followed by a drip section (not shown here), the hollow bodies 2, which are now provided with the gas barrier layer 3 and a covering layer, are led into a second dryer 17, whose design is substantially identical to the first dryer 14. The dryer 17 also has a closed housing 17a, into whose interior the conveyor 5 is screwed, this time from top to bottom. The drying of the second coating in the dryer 17 also occurs under mild conditions using warm air at approximately 45° C. with approximately 3 g water per cubic meter, where it is possible to omit an air dehumidification device. Instead, a recovery device 18 for the evaporated solvent of the second coating is provided. After drying the second coating, the hollow body 2, with finished coating, is transferred through the conveyor 5 to a delivery conveyor 19 or directly to its additional processing machine, for example, a stretch blow machine.

As a variant of the described and illustrated embodiment examples, it is possible to carry out the degreasing using other degreasing agents and/or other known installations. Instead of the flaming device, one can also use, for the purpose of subjecting a coating to a preliminary treatment, corona, plasma or HF treatment devices which in themselves are known, or similar devices. The discharging can also be carried out by other known means. The preliminary treatment section proposed according to the invention can also be used in coating devices for other plastics and/or with other coating agents. Besides applying by blowing, one can also apply the coatings by spraying, immersion or other known coating procedures. The drying can also be carried out by other known drying procedures such as, for example, infrared radiation or microwave radiation, in particular if the sensitivity of the coating agent is relatively low. The invention can also be used for coating internal surface, even when working with only one coating agent or when only one layer is applied.

1. Method for manufacturing hollow bodies with a gas barrier coating with a coating agent having a polyvinyl alcohol base, where a hollow body of surfaces to be treated is subjected to a preliminary treatment to increase surface energy, coated and then dried, comprising a multi-step preliminary treatment, where the hollow body is electrostatically discharged after the increase in the surface energy.

2. Method according to claim 1, where the surface energy is increased to a value above 60 mN/m.

3. Method according to claim 1 or 2, wherein the surface energy is increased by flaming.

4. Method according to claim 1, and an additional preliminary treatment with a fat dissolving agent, which preliminary treatment is carried out before the treatment to increase the surface energy.

5. Method according to claim 1, wherein the coating is carried out by blowing the coating agent against the surface to be treated.

6. Method according to, claim 1, wherein the drying is carried out with warm, dehumidified air at a temperature of less than approximately 60° C. and with a water content of less than approximately 3 g/m³.

7. Device for the manufacture of hollow bodies (2) with a gas barrier coating, in particular containers made of PET, in particular with a polyvinyl alcohol-based coating, comprising a device (8) to increase the surface energy of the surface to be coated, a coating device (10), a dryer (14), and a multi-step preliminary treatment section (6) having a device (9) for electrostatically discharging the surface (2c) to be treated, which device is arranged after the device (8) to increase the surface energy.

8. Device according to claim 7, wherein the device (9) for electrostatically discharging is an air shower with ionized air.

9. Device according to claim 7 wherein the preliminary treatment section (6) contains a device (7) to degrease the surface (2c) to be coated, which device is arranged before the device (8) to increase the surface energy.

10. Device according to claim 7, and a film formation section (13), arranged between the coating device (10) and the dryer (14).

11. Device according to claim 10, wherein the dryer is a warm air dryer and contains a dehumidification device (15) for the dryer air.

12. Device according to claim 7, and a second coating device (16) follows immediately after the dryer (14) for drying the gas barrier layer, for applying an additional layer which covers the gas barrier layer, and in that an additional dryer (17) for the second layer follows.

13. Method according to claim 2, where the surface is increased to a value above 760 mN/m.

14. Method according to claim 4, wherein the fat dissolving agent comprises ethyl alcohol.

15. Method according to claim 6, wherein the air temperature is less than approximately 45° C.
